(19) United States
(12) Patent Application Publication
(10) Pub. No.: US 2015/0003081 A1
(43) Pub. Date: Jan. 1, 2015

(54) Auxiliary Light Source Unit, Optical Element, And Mobile Electronic Device

(71) Applicant: KONICA MINOLTA, INC., Chiyoda-ku (JP)

(72) Inventors: Daisuke Kobayashi, Chiyoda-ku (JP); Yuki Naoi, Chiyoda-ku (JP); Yuki Ono, Chiyoda-ku (JP)

(21) Appl. No.: 14/372,767

(22) PCT Filed: Dec. 8, 2012
(86) PCT No.: PCT/JP2012/081862

§ 371 Date: Jul. 17, 2014

(30) Foreign Application Priority Data
Jan. 18, 2012 (JP) 2012-008220

(51) Int. Cl. F21V 5/04; G03B 15/05; G02B 3/02

(52) U.S. Cl. CPC F21V 5/04; G02B 3/02; G03B 15/05; F21Y 2101/02
USPC 362/311.02; 362/326

(57) ABSTRACT

In an auxiliary light source unit, when the longest length of a light emitting face of an LED light source is S (mm), the furthest distance from the light emitting face of the LED light source to the light exiting surface of an optical element is T (mm), the largest diameter of the light transmitting section is L1 (mm), and the largest diameter in first partial ring zones and second partial ring zones is L2 (mm), the following conditional expressions are satisfied,

1.5<L2/S<4.0 (1)

S/3<T<25 (2)

0.1<L1·T/S<1.05 (3)

provided that T=T1+T2,
where T1 is a thickness (mm) from the light emitting face of the LED light source to the light entering surface of the optical element, and T2 is a thickness (mm), in the optical axis direction, of the optical element.

### TECHNICAL FIELD

The present invention relates to an auxiliary light source unit capable of emitting auxiliary light for taking an image, an optical element, and a mobile electronic device.

### BACKGROUND ART

For example, in the case of taking an image by using a camera mounted in a mobile terminal, in order to acquire a high quality image even when photographing an object with low brightness, there is a need which desires to emit auxiliary light or fill light (flash light). However, since a mounting space is small in a general mobile terminal, there is a demand which wants to miniaturize an optical system to guide light from an auxiliary light source as small as possible. Further, there is a demand which wants to use an LED light source in order to save energy. However, a quantity of light of the LED is small as compared with a Xe tube having been used for the conventional flash etc., and the LED has a Lambertian type lighting distribution characteristic. Accordingly, in order to obtain a required illumination intensity, a certain device is needed.

Here, Patent Literature 1 discloses an optical element to convert light emitted mainly from an LED light source into light with characteristics suitable for auxiliary light. On at least one of a light entering surface and a light exiting surface of such an optical element, a groove-shaped minute structure is disposed, and this structure is configured to control the exiting light.

### CITATION LIST

### Patent Literature

PTL 1: US Publication No. 2011/32712

### SUMMARY OF INVENTION

### Technical Problem

However, according to the technique of PTL 1, in order to secure light utilization efficiency on the whole region of a light entering angle to an optical element, the groove-shaped structure is required to be added on the both surfaces of the optical element. This arrangement is difficult in the point of manufacturing, which causes a problem that the arrangement leads to an increase of cost. On the other hand, in the case where the groove-shaped structure is disposed on only a light entering surface or a light exiting surface of the optical element, control for light rays becomes insufficient, which causes a problem that a sufficient quantity of light cannot be obtained.

Here, as mentioned above, from the viewpoint of manufacturing, it is desirable to dispose the groove-shaped structure on only one side of the optical element. However, according to FIG. 6 of PTL 1, in the case of attaching the structure on only one side, it is reported that rather than the groove-shaped structure disposed on the light entering side, the groove-shaped structure disposed on the light exiting side makes light utilization efficiency higher. However, even in the case where the groove-shaped structure is disposed on the light exiting side, as far as following FIG. 6 of PTL 1, at a light entering angle of 40 degrees or more, since light utilization efficiency becomes lower, usability becomes worse.

The present invention has been achieved in view of the problems in the conventional technology, and an object of the present invention is to provide an optical element for an auxiliary light source unit which provides luminous intensity distribution suitable as auxiliary light for taking an image, wherein the optical element ensures a sufficient quantity of light while keeping a smaller size and can be manufactured easily at low cost, and also to provide an auxiliary light source unit and a mobile electronic device which uses the optical element.

Here, in this specification, in the case of satisfying the following expression, it is assumed that the sufficient miniaturization has been achieved,

L2/S<4.0 (5)

wherein S is the longest length (mm) of a light emitting face of an LED light source, and L2 is the largest diameter in a first partial ring zone and a second partial ring zone.

### Solution to Problem

An auxiliary light source unit described in claim 1 includes an LED light source and an optical element disposed at a light emitting side of the LED light source,

wherein the optical element includes, at a light exiting side thereof, a light transmitting section which is shaped in a flat surface or a curved surface and is disposed at a position corresponding to a central portion of the LED light source, and a ring zone section configured to enclose a periphery of the light transmitting section,

wherein the ring zone section is divided in a circumferential direction into four sections which include a first pair of fan-shaped portions arranged to face each other across the light transmitting section and a second pair of fan-shaped portions arranged to be disposed between the first pair of fan-shaped portions,

wherein each of the first pair of fan-shaped portions includes a plurality of first partial ring zones each provided with an optical axis side surface (a side surface positioned near to the optical axis) and an optical axis outer side surface (a side surface positioned far from the optical axis),

wherein each of the second pair of fan-shaped portions includes a plurality of second partial ring zones each provided with an optical axis side surface and an optical axis outer side surface, wherein respective slope angles of the optical axis outer side surfaces of the first partial ring zones relative to the optical axis and respective slope angles of the optical axis outer side surfaces of the second partial ring zones relative to the optical axis are made different in at least a part thereof from each other,

wherein when the longest length of a light emitting face of the LED light source is S (mm), the furthest distance from the light emitting face of the LED light source to the light exiting surface of the optical element is T (mm), the largest diameter of the light transmitting section is L1 (mm), and the largest diameter in the first partial ring zones and the second partial ring zones is L2 (mm), the following conditional expressions are satisfied,

1.5<L2/S<4.0 (1)

S/3<T<2S (2)

0.1<L1·T/S<1.05 (3)

provided that T=T1+T2,
where T1 is a thickness (mm) from the light emitting face of the LED light source to the light entering surface of the optical element, and T2 is a thickness (mm), in the optical axis direction, of the optical element.

The auxiliary light source unit of the present invention is mounted, for example, in a mobile terminal, and is used to emit auxiliary light at the time of photographing an object by the camera function of the mobile terminal. According to the present invention, among light rays emitted from a portion near the center of the LED light source, light rays which have been emitted in a direction near the optical axis and have passed through the light transmitting section of the optical element are configured to advance without change in the case where the light transmitting section is made to a flat surface, or advance while being refracted in accordance with a curved surface in the case where the light transmitting section is made to the curved surface. On the other hand, light rays emitted from a peripheral portion of the LED light source and light rays emitted in a direction deviating from the optical axis among the light rays emitted from the portion near the center of the LED light source are configured to pass through the ring zone section so as to be refracted, whereby the light rays are used to irradiate effectively mainly a periphery of an object at a central portion. At this time, the slope angles of the optical axis outer side surfaces of the first partial ring zones relative to the optical axis and the slope angles of the optical axis outer side surfaces of the second partial ring zones relative to the optical axis are made different in at least a part of them from each other, whereby it becomes possible to adjust effectively the exiting angle of light rays emitted from the auxiliary light source unit, for example, light rays are emitted separately so as to be distributed to a wide range in the horizontal direction rather than the vertical direction for an object field. In addition, by using partial ring zones, it becomes possible to make the optical element in a smaller size and a lower height. In particular, by arranging the partial ring zones of the ring zone section in accordance with an angle distribution and a position distribution of light rays entering from the LED light source to the optical element, it becomes possible to control effectively the exiting angle of light rays exiting from the optical element.

Further, when the value of the expression (2) exceeds the lower limit within a range satisfying the expression (1), the optical element can be separated from the LED light source, so that variation in the entering direction of light rays entering a specific position of the ring zone section becomes small and it becomes easy to perform the control of the exiting direction of light rays. On the other hand, when the value of the expression (2) is lower than the upper limit, light rays emitted from the above-mentioned LED light source having the luminous intensity distributions, such as a Lambertian type, can be efficiently taken in by the optical element. With this, it becomes possible to ensure a quantity of light entering the above-mentioned ring zone section, whereby an optical system with high efficiency can be realized.

Furthermore, in the present invention, the exiting direction of light rays having entered the optical element is controlled by the refraction effect in the ring zone section. Accordingly, there is an actual situation that if variation in the entering direction of light rays entering a specific position of the ring zone section becomes smaller, it becomes easier to control the exiting direction of light rays. However, in a light source having a Lambertian type luminous intensity distribution like an LED light source, since an angle distribution of light rays entering an optical element becomes wider at a position right above the light source, the control by the ring zone section is not only effective, but also there is fear that light rays having entered the optical element return to the light source side by the total reflection of the ring zone section. In order to counter this, in the present invention, the condition of the expression (3) is added.

In more concrete terms, when the value of the expression (3) exceeds the lower limit, the light transmitting section can be disposed in a prescribed range right above the LED light source, and the ring zone section can be separated, whereby it becomes possible to avoid a problem that light rays cannot be controlled in good order due to the total reflection. Further, there is also an advantage that a work amount for a metal mold to form the optical element can be reduced. On the other hand, when the value of the expression (3) is lower than the upper limit, the ring zone section can be disposed sufficiently widely. Accordingly, it becomes possible to control effectively light rays emitted from the LED light source. Furthermore, with the expression (1) and (3), the light transmitting section being a flat surface or a curved surface can be made in a suitable size, whereby it becomes unnecessary to process a ring zone section needlessly so that a decrease of cost by the reduction of the number of processes can be expected.

In the invention described in claim 1, the auxiliary light source unit described in claim 2 is configured to satisfy the following expression.

T2/T<0.5 (4)

By satisfying the expression (4), many of light rays which are emitted from the LED light source and enter the optical element are made to advance with an inclination relative to the optical axis of the optical element. With this, an optical path length passing through an air layer can be secured to be long, whereby it becomes possible to suppress the thickness of the optical element.

In the invention described in claim 1 or 2, the auxiliary light source unit described in claim 3 is constituted such that a mountain-shaped upraised portion is disposed in a boundary between the first partial ring zone and the second partial ring zone.

Generally, since the effective pixel region of an image pickup sensor is shaped in a rectangular form, a range to be irradiated with auxiliary light becomes a rectangular region in an object region. That is, it becomes important to make a certain quantity of auxiliary light reach up to the four corners (diagonal directions) of the rectangular region serving as an object region. According to the present invention, by disposing the mountain-shaped upraised portion, light rays having passed through the mountain-shaped upraised portion among light rays emitted from the LED light source can be made to advance toward the four corners of the rectangular region without being refracted greatly at the ring zone section. Accordingly, it becomes possible to prevent an illumination intensity at each of diagonal direction edge portions of the rectangular region from excessively lowering as compared with the central portion. Further, in the case where the optical element is molded with a metal mold, a mold processing process becomes easy at the boundary portion between the first partial ring zone and the second partial ring zone, which enables the lowering of manufacturing cost. However, the first partial ring zone and the second partial ring zone may come in contact with each other.

In the invention described in any one of claims 1 to 3, the auxiliary light source unit described in claim 4 is constituted such that the slope angle of the optical axis outer side surface of at least one of the first partial ring zone and the second partial ring zone decreases gradually from a side near the optical axis toward a peripheral portion.

In the case where light rays emitted from the LED light source having a Lambertian type luminous intensity distribution enter the optical element, an angle formed between the advancing direction of the light rays and the optical axis is made larger on a ring zone at a peripheral side rather than a ring zone at the center side. Accordingly, a refractive power required for a ring zone in order to make light rays reach a range to be irradiated with light rays is made larger at the peripheral side rather than the center side. According to the present invention, the slope angle of the optical axis outer side surface of at least one of the first partial ring zone and the second partial ring zone is made to decrease gradually from a side near the optical axis toward a peripheral portion, whereby the refractive power of a ring zone is made gradually larger from the central side toward the peripheral side. Therefore, it becomes possible to prevent an illumination intensity at each of longitudinal direction end portions of the rectangular region from excessively lowering as compared with the central portion while securing a quantity of light arriving at the rectangular region.

In the invention described in any one of claims 1 to 4, the auxiliary light source unit described in claim 5 is constituted such that a groove depth in a ring zone of at least one of the first partial ring zone and the second partial ring zone is made to increase from a side near the optical axis toward a peripheral portion.

In the case where the optical element is molded from a metal mold, even when the slope angle of the optical axis outer side surface of the partial ring zone section is made small, it becomes unnecessary to thin extremely the tip of a tool to shape a metal mold corresponding to the partial ring zone section, which enables the adjustment of an angle of exiting light rays while reducing manufacturing cost.

In the invention described in any one of claims 1 to 5, the auxiliary light source unit described in claim 6 is constituted such that on the optical element, a discrimination mark to discriminate the first pair of fan-shaped portions and the second pair of fan-shaped portions from each other is formed.

With discrimination of the discrimination mark to discriminate the first pair of fan-shaped portions and the second pair of fan-shaped portions from each other, an inserting direction at the time of inserting the auxiliary light source unit together with an imaging device in an apparatus can be visually acknowledged securely, whereby it becomes possible to prevent the auxiliary light source unit from being inserted in the wrong direction.

An optical element described in claim 7 is an optical element arranged in an auxiliary light source unit including an LED light source at a light emitting side of the LED light source,

wherein the optical element includes, at a light exiting side thereof, a light transmitting section which is shaped in a flat surface or a curved surface and is disposed at a position corresponding to a central portion of the LED light source, and a ring zone section configured to enclose a periphery of the light transmitting section,

wherein the ring zone section is divided in a circumferential direction into four sections which include a first pair of fan-shaped portions arranged to face each other across the light transmitting section and a second pair of fan-shaped portions arranged to be sandwiched between the first pair of fan-shaped portions,

wherein each of the first pair of fan-shaped portions includes a plurality of first partial ring zones each provided with an optical axis side surface and an optical axis outer side surface,

wherein each of the second pair of fan-shaped portions includes a plurality of second partial ring zones each provided with an optical axis side surface and an optical axis outer side surface,

wherein respective slope angles of the optical axis outer side surfaces of the first partial ring zones relative to the optical axis and respective slope angles of the optical axis outer side surfaces of the second partial ring zones relative to the optical axis are made different in at least a part thereof from each other,

wherein when the longest length of a light emitting face of the LED light source is S (mm), the furthest distance from the light emitting face of the LED light source to the light exiting surface of the optical element is T (mm), the largest diameter of the light transmitting section is L1 (mm), and the largest diameter in the first partial ring zones and the second partial ring zones is L2 (mm), the following conditional expressions are satisfied,

1.5<L2/S<4.0 (1)

S/3<T<2S (2)

0.1<L1·T/S<1.05 (3)

provided that T=T1+T2,
where T1 is a thickness (mm) from the light emitting face of the LED light source to the light entering surface of the optical element, and T2 is a thickness (mm), in the optical axis direction, of the optical element.

A mobile electronic device described in claim 8 is configured to mount the auxiliary light source unit described in any one of claims 1 to 6.

The auxiliary light source unit according to the present invention includes an LED (Light Emitting Diode) light source and an optical element.

As the LED light source, various LED light sources may be used. However, a white LED may be used preferably.

As the white LED, a combination of a blue LED chip and a phosphor, such as a YAG phosphor which emits yellow light rays in response to blue light rays emitted from a blue LED chip may be used preferably. However, a white LED which forms white light rays by combining a blue LED chip, a green LED chip, and a red LED chip may be also used. Further, as the white LED, for example, a white LED described in Japanese Unexamined Patent Publication No. 2008-231218 may be used. However, the white LED should not be limited to this.

The white LED light source may be preferably constituted with an LED chip and a phosphor layer formed so as to cover the LED chip. As one example of the LED chip, an LED chip configured to emit light rays with a first prescribed wavelength is used, and for example, is configured to emit blue light rays. However, the wavelength of the LED chip and the wavelength of the phosphor should not be limited, and in a combination of the LED chip and the phosphor, if the wavelength of light rays emitted from the LED chip and the wavelength of light rays emitted from the phosphor are in a complementary color relation and light rays synthesized from them become white light rays, such a combination can be used.

Here, as such a LED chip, a well-known blue LED chip may be used. As a blue LED chip, in addition to an InxGa1-xN system LED chip, various existing LED chips can be used. The peak wavelength of light rays emitted from a blue LED chip is preferably 440 to 480 nm. Further, as the configuration of the LED chip, various configurations of LED chips may be employed, such as a type in which an LED chip is mounted on a base plate and configured to emit light rays upward or to the side without change, and a so-called flip chip connection type in which a blue LED chip is mounted on a transparent base plate such as a sapphire base plate, a bump is formed on its surface, and the blue LED chip is reversed and connected to electrodes on the base plate.

The phosphor layer preferably includes a phosphor which converts light rays with first prescribed wavelength emitted from a LED chip into light rays with a second prescribed wavelength.

Examples of the phosphor includes a phosphor which converts blue light rays emitted from a LED chip into yellow light rays.

For the phosphor used for such a phosphor layer, as raw materials such as Y, Gd, Ce, Sm, Al, La, and Ga, oxidized materials or compounds which become easily oxidized material at a high temperature are used and sufficiently mixed at a stoichiometric proportion, thereby obtaining raw materials. Alternatively, rare earth elements such as Y, Gd, Ce, and Sm are dissolved in acids at a stoichiometric proportion, and the resulting solution is coprecipitated with oxalic acid. Successively, the coprecipitate is calcined so as to obtain a coprecipitation oxide, and then the coprecipitation oxide, aluminum oxide and gallium oxide are mixed, thereby obtaining a mixed raw material. Subsequently, a proper quantity of fluorides, such as ammonium fluoride, are mixed as flux to the above mixed raw material, and the resulting mixture is pressed so as to obtain a compact. Then, the compact is filled in a crucible, and calcined under a temperature range of 1350 to 1450° C. for 2 to 5 hours in air, whereby a sintered material with the luminescence property of phosphor can be obtained.

Further, the LED light source may include a single LED chip, or may include a plurality of LED chips. In the case of using a single LED chip, the longest length S of the light emitting face of the LED light source in the expression (1) is taken on the diagonal line of the LED chip CP, as shown in FIG. 1(a). On the other hand, in the case of using a plurality of LED chips, when a phosphor layer YL is formed so as to cover the plurality of LED chips CP, the longest length S of the light emitting face of the LED light source is made as the diameter or diagonal length of the phosphor layer YL, as shown with a dotted line in FIG. 1(b). However, when the phosphor layer is not disposed, the longest length S is made to the diameter of a minimum circle circumscribing the plurality of LED chips CP. Here, when the LED chip is a rectangle, it is desirable that the longitudinal direction of the rectangle is made to coincide with a direction (in the following embodiment, the Y direction) in which exiting light rays from an optical element spreads.

It is desirable that the LED light source is a high power LED light source. Here, the high power LED light source may be constituted with an LED with an output of 0.5 W or more.

It is desirable that the optical element is constituted with glass or plastic. As the plastic constituting a lens, for example, by using a polycarbonate or acrylic resin, the lens can be manufactured by injection molding, which can reduce a manufacturing cost. Further, in recent years, as a method of mounting a large quantity of lens modules on a base plate at low cost, the following technique has been proposed. Lens modules are placed together with IC (Integrated Circuit) chips and other electronic parts on a base plate on which solder has been subjected to potting beforehand. Successively, in the state of being placed, these components are subjected to a reflow process (heat treatment) with which the solder is melted, whereby the lens modules and the electronic parts are mounted simultaneously on the base plate. Accordingly, by using resin which is excellent in heat resistance durable against the reflow process, it becomes possible to subject lens modules placed on a base plate to the reflow process, whereby mass production can be achieved at low cost. Further, the optical element may be molded by glass molding. Furthermore, the above-mentioned light transmitting sections and ring zone sections are formed by an energy curable resin on a glass plate or a resin plate, and thereafter, a combination of a light transmitting section and ring zone sections are cut out separately from other combinations, whereby a large number of optical elements can be produced, which can reduce a manufacturing cost.

Between an LED light source and an optical element, a spacer with a reflector may be arranged. Here, the reflector is used to reflect light rays emitted from the LED light source, and it is desirable that the reflector includes a diffusing surface.

### Advantageous Effects of Invention

According to the present invention, it becomes possible to provide an optical element for an auxiliary light source unit which provides luminous intensity distribution suitable as auxiliary light for taking an image, wherein the optical element can ensure a sufficient quantity of light while keeping a smaller size and can be manufactured easily at low cost, and also to provide an auxiliary light source unit and a mobile electronic device which uses the optical element.

### BRIEF DESCRIPTION OF DRAWINGS

FIG. 1 is an illustration showing a dimension S of an LED light source.

FIG. 2 is a perspective view of an auxiliary light source unit 10 according to the present embodiment.

FIG. 3 is a view of an auxiliary light source unit 10 according to the present embodiment which is looked from a light emitting face side.

FIG. 4 is a view of a constitution of FIG. 3 which is cut along an IV-IV line and looked in an arrow direction.

FIG. 5 is a fluoroscopic perspective view of the auxiliary light source unit 10.

FIG. 6 is an outline cross sectional view of partial ring zones RPx and RPy.

FIG. 7 is an outline cross sectional view of the partial ring zone RPx.

FIG. 8 is a perspective view of an auxiliary light source unit according to another embodiment.

FIG. 9 is a cross sectional view of a mountain-shaped upraised portion.

FIG. 10 is a cross sectional view of a metal mold configured to transfer and mold partial ring zones.

FIG. 11 is an illustration for describing a performance evaluation method for an optical element.

FIG. 12 is an illustration of a light exiting side in each of Examples 1 to 13.

FIG. 13 is an illustration of a light exiting side in Example 14.

FIG. 14 is an illustration of a light exiting side in Example 15.

FIG. 15a is a front view of a mobile electronic device (a smart phone) in which an auxiliary light source unit according to the present embodiment can be mounted, and FIG. 15b is a back view of the mobile electronic device

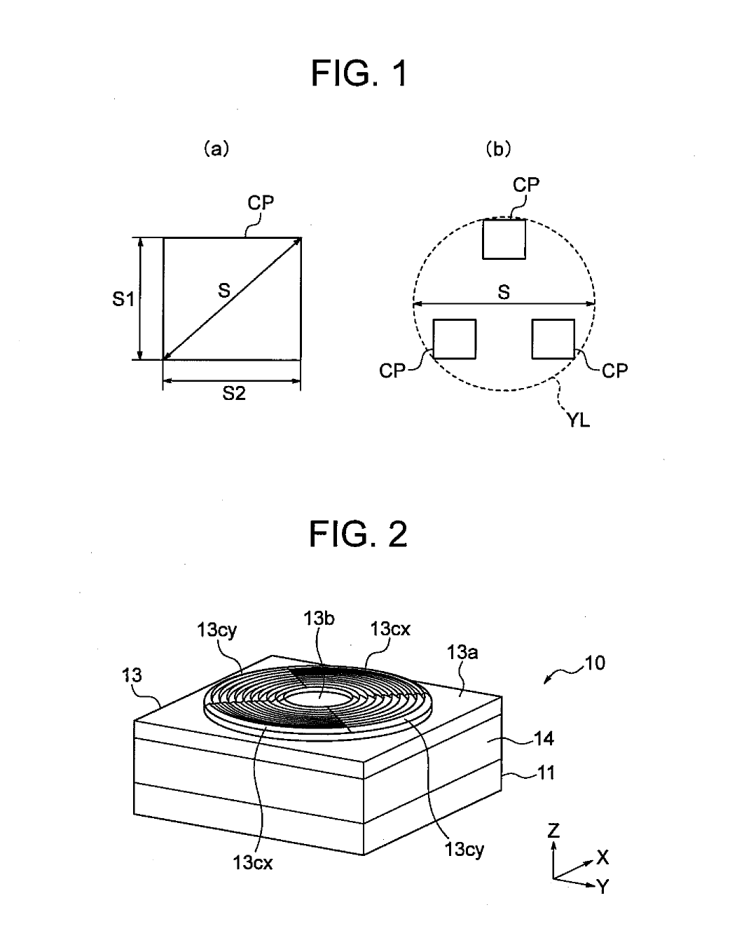

### DESCRIPTION OF EMBODIMENTS

Hereafter, with reference to the attached drawings, the embodiments of the present invention will be described. Here, the dimensional ratio in the drawings may be exaggerated on account of description, and may be different from the actual ratio.

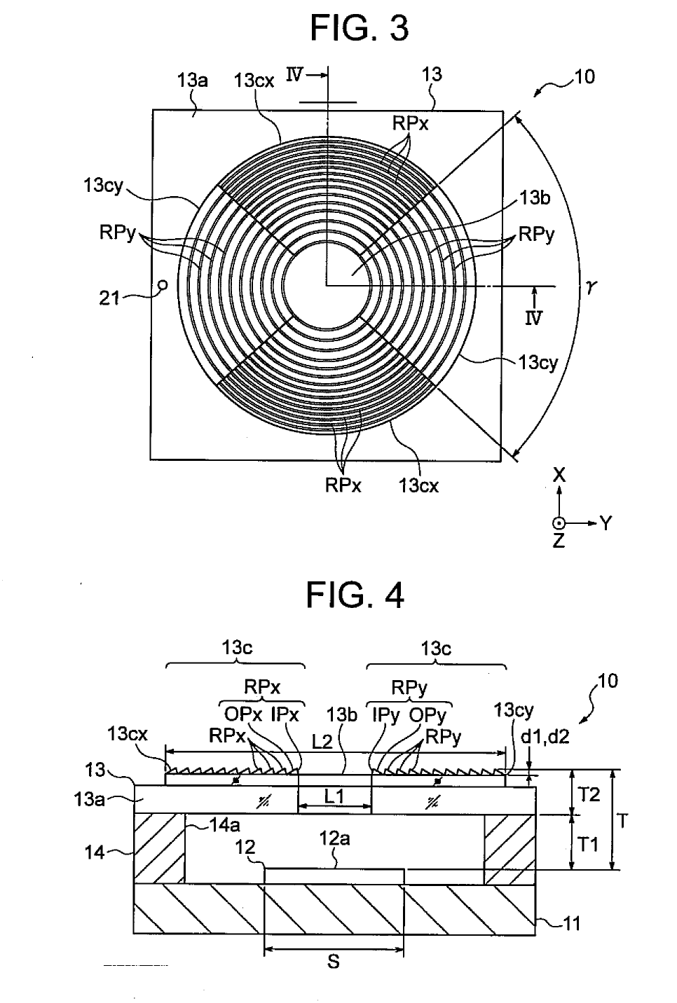

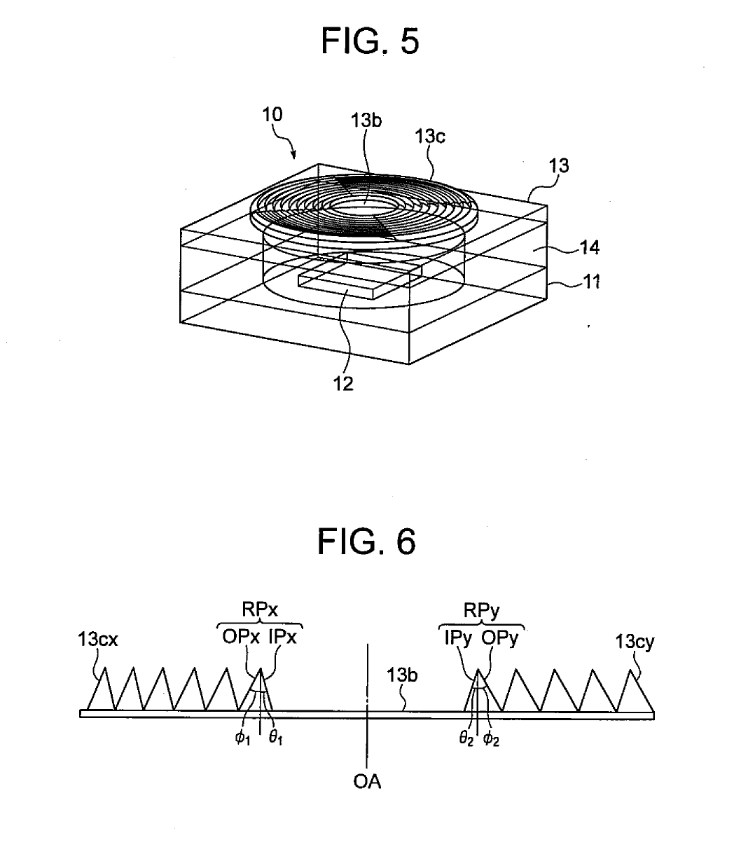

FIG. 2 is a perspective view of the auxiliary light source unit 10 according to this embodiment. FIG. 3 is a view of an auxiliary light source unit 10 according to the present embodiment which is looked from a light emitting face side. FIG. 4 is a view of a constitution of FIG. 3 which is cut along an IV-IV line and looked in an arrow direction. FIG. 5 is a fluoroscopic perspective view of the auxiliary light source unit 10. Here, in the drawings, the optical axis direction of an optical element is defined as a Z direction, a direction perpendicular to the Z direction is defined as an X direction, and a direction perpendicular to both the Z direction and the X direction is defined as a Y direction.

As shown in FIGS. 3 and 4, the auxiliary light source unit 10 according to this embodiment is constituted by an LED light source 12 mounted on a rectangle-shaped base plate 11, an optical element 13 which is disposed on the light emitting side of the LED light source 12 and has a rectangle-shaped outer form, and a spacer 14 arranged between the LED light source 12 and the optical element 13. As shown in FIG. 5, a spacer 14 has a square tube-shaped outer form and a cylindrical tube-shaped inner form. Its lower end is secured with adhesive to the top surface of the base plate 11, and its upper end is secured with adhesive to the bottom surface of the optical element 13. The inner circumferential surface 14a of the spacer 14 is made to a light diffusing surface (white color-coated surface).

The base plate 11 is roughly constituted by a base plate body made of aluminum, an insulating layer laminated on the base plate body, and a wiring pattern composed of conductors, such as Cu, formed on the insulating layer. To the wiring pattern, an LED chip constituting the LED light source 12 is connected. The LED light source is configured to forma a surface-shaped light source.

In the LED light source 12, the LED chip is thoroughly covered with a phosphor containing transparent resin body (phosphor containing transparent resin) shaped in a rectangular flat plate by molding. The LED light source 12 is constituted such that all of light rays emitted from the LED chip pass through the phosphor containing transparent resin body. With this constitution, for example, in the case where a blue light emitting diode is used as the LED chip and a yellow phosphor is used as the phosphor contained in the phosphor containing transparent resin, it becomes possible to emit white light rays. Here, it may be preferable that the LED chip is shaped in a rectangle with sides extending in the X direction and the Y direction respectively.

The optical element 13 is configured such that, on a parallel flat plate 13a (light exiting side), a light transmitting section 13b shaped in a circular flat surface (or a curved surface) is disposed at the central portion and a ring zone section 13c is disposed to enclose the periphery of the light transmitting section 13b. The optical axis of the optical element 13 is made to pass through the center of the light transmitting section 13b. The parallel flat plate 13a, the light transmitting section 13b, and the ring zone section 13c may be formed integrally, or may be molded separately and joined to each other in one body. In the case where they are molded separately, their respective materials may be different from each other. The ring zone section 13c may be formed directly on the parallel flat plate 13a, or may be disposed via a transparent disc between them as shown in the drawing. The method of producing the optical element 13 includes various methods, such as an injection molding method, a shaving method, a method of forming the light transmitting section 13b and the ring zone section 13c on a parallel flat plate by using a metal mold, and a glass molding method. In this embodiment, it is supposed that the optical element 13 is transferred and molded by a metal mold corresponding to four divided fan-shaped portions.

As shown in FIG. 3, the ring zone section 13c is divided into four portions in the circumferential direction, and the four portions include a (first) pair of fan-shaped portions 13cx which face each other in the X direction across the light transmitting section 13b, and a (second) pair of fan-shaped portions 13cy which face each other in the Y direction across the light transmitting section 13b and are sandwiched between the pair of fan-shaped portions 13cx. The fan-shaped portions 13cx and 13cy come in contact with each other. As shown in FIG. 4, each of the pair of fan-shaped portions 13cx includes a plurality of first partial ring zones RPx around a center positioned at the optical axis, and each of the plurality of first partial ring zones RPx has an optical axis side surface IPx and an optical axis outer side surface (optical axis outside surface) OPx. Further, each of the pair of fan-shaped portions 13cy includes a plurality of second partial ring zones RPy around a center positioned at the optical axis, and each of the plurality of second partial ring zones RPy has an optical axis side surface IPy and an optical axis outer side surface OPy. In this embodiment, the height d1 of the first partial ring zone RPx and the height d2 of the second partial ring zone RPy are equal to each other. Here, in FIG. 4, as a matter of convenience in illustration, the fan-shaped portions 13cx and 13cy are illustrated so as to face each other. However, actually, the fan-shaped portions 13cx and 13cy never face each other. Further, on the light exiting side of the optical element, in order to distinguish the (first), pair of fan-shaped portions 13cx and the (second) pair of fan-shaped portions 13cy from each other, a boss-shaped protruding portion 21 is formed. The protruding portion 21 is a discrimination mark and shows the direction of the ring zone sections (in this example, the arrangement direction of the pair of fan-shaped portions 13cy) at the time of inserting this auxiliary light source unit together with an imaging device in an apparatus. With this, it becomes possible to confirm the X direction and the Y direction at the time of the inserting. Accordingly, the protruding portion 21 is used to prevent the fan-shaped portions from being inserted in the wrong direction.

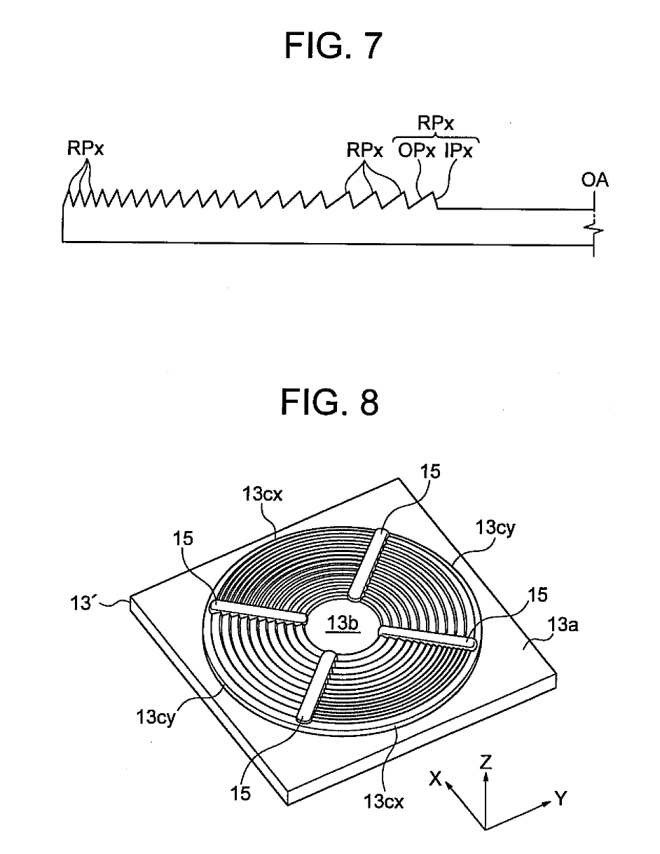

In FIG. 6 showing schematically the cross section of each of the first partial ring zones RPx and the second partial ring zones RPy, the slope angle φ 1 of the optical axis outer side surface OPx of the first partial ring zone RPx relative to the optical axis OA and the slope angle φ 2 of the optical axis outer side surface OPy of the second partial ring zone RPy relative to the optical axis OA are different from each other on at least a certain portion. More preferably, although the slope angle φ 2 of the optical axis outer side surface OPy of the second partial ring zone RPy is constant, the slope angle φ 1 of an optical axis outer side surface OPx of the first partial ring zone RPx becomes gradually small as the position of the optical axis outer side surface OPx shifts from the center side toward the peripheral side, as shown in FIG. 7. That is, as shown in FIG. 2, although the pitch of the second partial ring zones RPy is an equal pitch, the pitch of the first partial ring zones RPx becomes gradually small as the position of a first partial ring zone RPx shifts from the center side toward the peripheral side. Here, the slope angle θ1 of the optical axis side surface IPx of the first partial ring zone RPx and the slope angle θ2 of the optical axis side surface IPy of the second partial ring zone RPy may be equal to or different from each other. In this embodiment, they are made equal to each other.

As shown in FIG. 4, when the diagonal length of the light emitting face (top face 12a) of the LED light source 12 is S (mm), a distance from the light emitting face of the LED light source 12 to the furthest side of the light exiting surface of the optical element 13 (in this embodiment, up to the leading edge of each of the partial ring zones RPx and RPy) is T (mm), the largest diameter of the light transmitting section 13b is L1 (mm), and the largest diameter in any one of the first partial ring zones RPx and the second partial ring zones RPy is L2 (mm), the following conditional expressions are satisfied.

1.5<L2/S<4.0 (1)

S/3<T<2S (2)

0.1<L1·T/S<1.05 (3)

Provided that T=T1+T2,
where T1 is a thickness (mm) from the light emitting surface of the LED light source 12 to the light entering surface of the optical element 13, and T2 is a thickness (mm), in the optical axis direction, of the optical element 13.

In the case of mounting the auxiliary light source unit 10 according to this embodiment in a mobile terminal and the like, the X direction is made to a short side direction (vertical direction) of an image sensor, and the Y direction is made to a long side direction (horizontal direction) of the image sensor. At the time of photographing an object by using the camera function of a mobile terminal, the auxiliary light source unit 10 is configured to emit light rays. At this time, light rays are emitted from the LED light source and pass through the light transmitting section of the optical element. Successively, in the case where the light transmitting section is made to a flat surface, the light rays advance without change in the direction, and in the case where the light transmitting section is made to a curved surface, the light rays advance while being refracted in accordance with the curved surface.

On the other hand, among the light rays which have entered the optical element 13 and have passed through the parallel flat plate 13a, light rays which have entered a pair of fan-shaped portions 13cx are refracted on the optical axis outer side surfaces OPx of the first partial ring zones RPx, and thereafter, exit toward an object. Further, among the light rays which have entered the optical element 13 and have passed through the parallel flat plate 13a, light rays which have entered a pair of fan-shaped portions 13cy are refracted on the optical axis outer side surfaces OPy of the second partial ring zones RPy, and thereafter, exit toward the object. At this time, since the slope angle φ 1 of the optical axis outer side surface OPx is smaller than the slope angle φ 2 of the optical axis outer side surface OPy of the second partial ring zone RPy, light rays which advance in the X direction (vertical direction) are refracted greatly. In contrast, light rays which advance in the Y direction (horizontal direction) are refracted at an angle smaller than that of the light rays advancing in the X direction. With this, since light rays emitted from the auxiliary light source unit 10 have an irradiation range wider in the horizontal direction than the vertical direction, the auxiliary light source unit 10 can perform irradiation matching with the image pick-up screen.

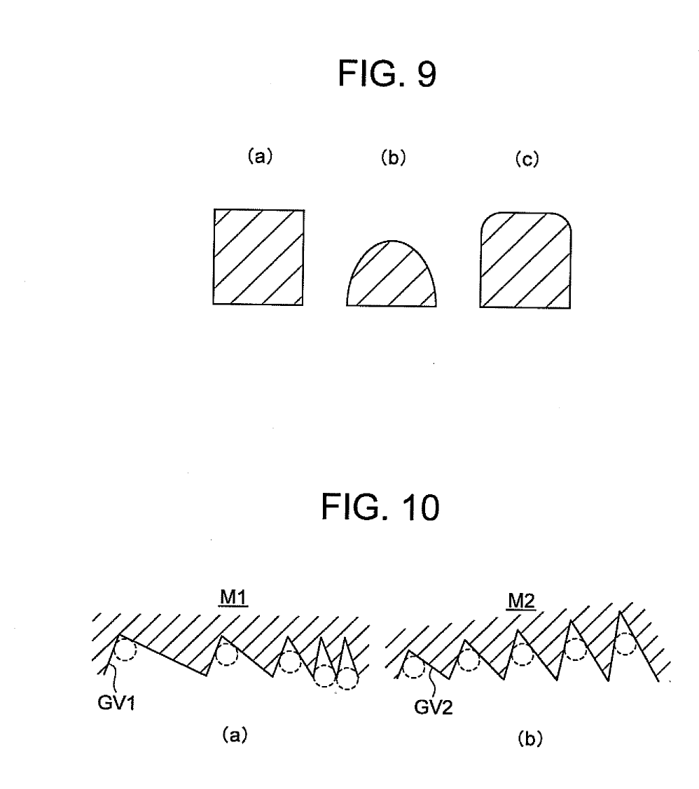

FIG. 8 is a perspective view of an optical element 13′ according to another embodiment. This embodiment is different in a point that at the boundary portions between a (first) pair of fan-shaped portions 13cx which face each other in the X direction across a light transmitting section 13b and a (second) pair of fan-shaped portions 13cy which face each other in the Y direction across the light transmitting section 13b, mountain-shaped upraised portions 15 are disposed so as to extend straight in the direction perpendicular to the optical axis. That is, on the portions where the mountain-shaped upraised portions 15 are disposed, a ring zone section is not formed. As shown with a cross section cut in the direction perpendicular to the longitudinal direction in FIG. 9, various configurations employed for the mountain-shaped upraised portions 15 include a rectangular cross section shown in FIG. 9(a), a semicircular cross section shown in FIG. 9(b), and a rectangular cross section shown in FIG. 9(c) in which each of corners at the light exiting side is formed with an arc.

According to this embodiment, by disposing the mountain-shaped upraised portions 15, among light rays emitted from the LED light source 12, light rays having passed through the mountain-shaped upraised portion 15 are enabled to advance to the four corners of a rectangular region indicated virtually on the periphery of an object without being refracted. Accordingly, it becomes possible to prevent illumination intensity at each of diagonal direction end portions of the rectangular region from excessively lowering as compared with that of the central portion. Further, in the case where the optical element 13′ is molded with a single metal mold, at the time of manufacturing partial ring zones with a NC machine, portions corresponding to the mountain-shaped upraised portions 15 are made to serve as escape portions for a tool. With this, a mold machining process is made easy, which enables the lowering of manufacturing cost.

In the above-mentioned embodiment, the respective heights of the partial ring zones RPy are equal to each other. However, the height of a partial ring zone RPy of the partial ring zones RPy may be made to become higher gradually as the position of the partial ring zone RPy shifts from the optical axis side toward a peripheral side. In other words, a ring zone groove depth between neighboring partial ring zones RPy is made to become deeper gradually as the position of the neighboring partial ring zones RPy shifts from the optical axis side toward a peripheral side. The effect attained by this constitution is described by using FIG. 10.

FIG. 10 is a cross sectional view of a metal mold configured to transfer and form partial ring zones RPy. In a metal mold M1 shown in FIG. 10(a), the metal mold M1 is configured to transfer and form partial ring zones RPy with respective heights made equal to each other. In this case, the groove width of a transfer groove GV1 becomes narrower gradually as the position of the transfer groove GV1 shifts from the center toward a periphery side (right side in the drawing). Accordingly, at the time of cutting a transfer groove GV1 positioned at the most peripheral side, it is necessary to use a tool with a narrow width, which causes the increasing of manufacturing cost.

In contrast, in the case where the height of a partial ring zone RPy is made to become higher gradually as the position of the partial ring zone RPy shifts from the optical axis side toward a periphery side, the depth of a transfer groove GV2 configured to transfer and form a partial ring zone RPy in a metal mold M2 shown in FIG. 10(b) becomes deeper gradually as the position of the transfer groove GV2 shifts from the center toward a periphery side (right side in the drawing). However, the respective groove widths of the transfer grooves GV2 are not almost different from each other. Accordingly, it becomes possible to cut all the transfer grooves GV2 with a tool with the same width, which enables the lowering of manufacturing cost.

Next, with reference to FIGS. 15(a) and 15(b), description will be given to examples of mobile electronic devices on which the auxiliary light source unit according to this embodiment can be mounted. As shown in FIG. 15(a), a smart phone (multifunctional mobile telephone) SF being one of the mobile electronic devices is equipped, at its front, with a liquid crystal input display section DP which has an information display function and an information input function, and further equipped, at its inner portion, with a camera unit and an auxiliary light source unit. As shown in FIG. 15(b), the smart phone SF is equipped, at its back, with a camera window CW corresponding to the inner cameral unit, and further equipped, in the vicinity of the camera window CW, with an auxiliary light window AW corresponding to the inner auxiliary light source unit. As the auxiliary light source unit of the smart phone SF, the auxiliary light source unit 10 of this embodiment can be used. At the time of photographing an object with the camera unit of the smart phone SF, auxiliary light (flash light) is emitted from the LED light source 12 of the auxiliary light source unit 10 shown in FIGS. 2 to 4 via the optical element 13, and irradiated to the object through the auxiliary light window AW shown in FIG. 15(b).

### EXAMPLES

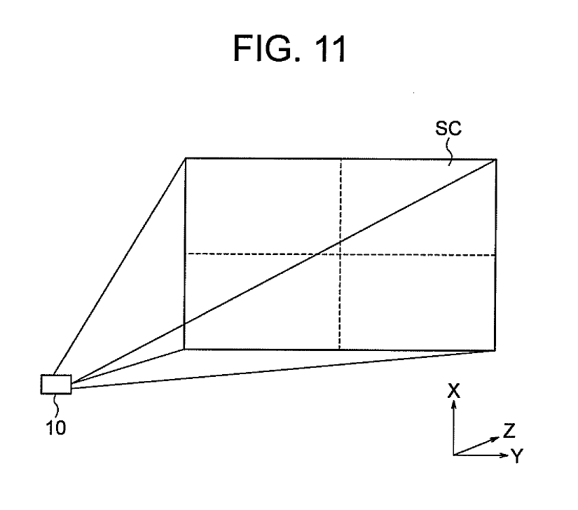

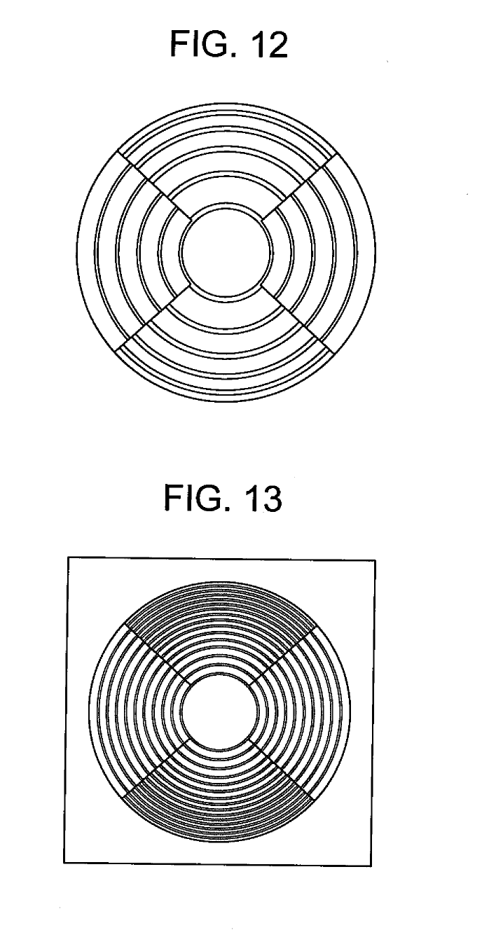

The present inventors have produced examples suitable for the above-mentioned embodiments. Here, description is given to the performance evaluation method for optical elements which the present inventors have performed. As shown in FIG. 11, a rectangular screen SC with a size of 828 mm long and 1064 mm wide was prepared, and arranged at a position distant by 1000 mm from the front of the auxiliary light source unit 10 so as to make the optical axis of the optical element face the center of the screen SC. On such a condition, an LED light source (an LED chip was shaped in a square) with 270 [Lumen] was made to emit light, and illumination intensity on the screen SC was measured. In the evaluation, it is assumed that a quantity of light arriving at the screen SC is provided with the top priority and the “efficiency” is calculated by dividing (a quantity of light arriving at the screen SC [Lumen]) with (a quantity of light emitted from the LED light source [Lumen]). Here, the used LED light source was a type with a square-shaped light emitting face. Further, as a spacer, a light diffusing face with an inner diameter of 3.0 mm and an inner peripheral surface having a reflectance of 90% was used.

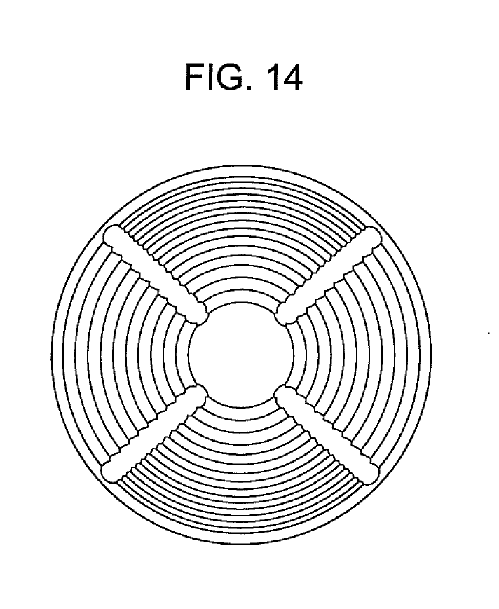

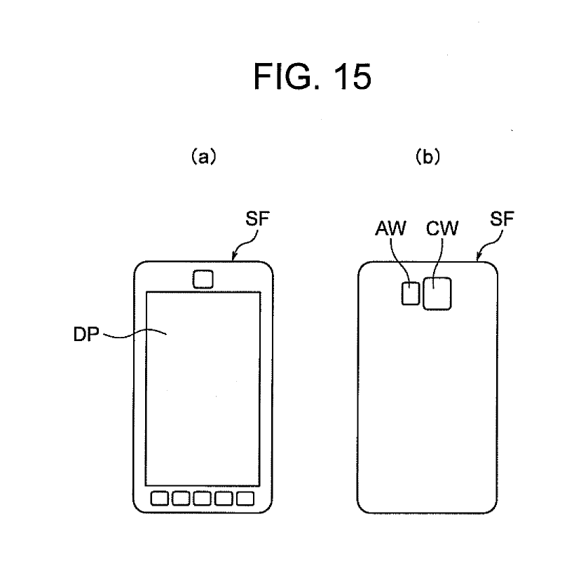

The values indicated in expressions (1) to (3) and the values indicated in FIG. 4 in each of Examples 1 to 15 and Comparative examples 1 to 3 are shown in Table 1. In this connection, in each of Examples 1 to 13 and Comparative examples 1 to 3, there was not provided a mountain-shaped upraised portion, and the number of each of the partial ring zones RPx and RPy was 5. In Example 14, there was not provided a mountain-shaped upraised portion, the number of the partial ring zones RPx was 15, and the number of the partial ring zones RPy was 10. Further, In Example 15, there were provided mountain-shaped upraised portions, the number of the partial ring zones RPx was 15, and the number of the partial ring zones RPy was 10. The term “Sweep angle” in Table means an angle γ of the partial ring zone RPy (refer to FIG. 3). Between Examples and Comparative examples, although the value of S was made the same, the value of T and the value of L1(T1+T2)/S were made different. FIG. 12 is an illustration at the light exiting side in each of Examples 1 to 13, FIG. 13 is an illustration at the light exiting side in Example 14, and FIG. 14 is an illustration at the light exiting side in Example 15.

TABLE 1
[Parameter List]

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| | S | 1.976 | 1.976 | 1.976 | 1.976 | 1.976 | 1.976 | 1.976 | 1.976 | 1.976 | 1.976 |
| | S1 | 1.397 | 1.397 | 1.397 | 1.397 | 1.397 | 1.397 | 1.397 | 1.397 | 1.397 | 1.397 |
| | S2 | 1.397 | 1.397 | 1.397 | 1.397 | 1.397 | 1.397 | 1.397 | 1.397 | 1.397 | 1.397 |
| | L1 | 1 | 1 | 1 | 1 | 1 | 1 | 1 | 1 | 0.2 | 0.3 |
| | T1 | 0.6 | 0.6 | 0.6 | 0.6 | 0.6 | 0.6 | 0.6 | 0.8 | 0.5 | 0.65 |
| | T2 | 0.618 | 0.648 | 0.648 | 0.618 | 0.664 | 0.648 | 0.578 | 0.547 | 0.720 | 0.711 |
| | T | 1.218 | 1.248 | 1.248 | 1.218 | 1.254 | 1.248 | 1.278 | 1.447 | 1.220 | 1.361 |
| | L2 | 3.4 | 3.4 | 3.4 | 3.4 | 3.4 | 3.4 | 3.4 | 3.4 | 3.4 | 3.4 |
| | L2/S | 1.72 | 1.72 | 1.72 | 1.72 | 1.72 | 1.72 | 1.72 | 1.72 | 1.72 | 1.72 |
| | L1(T1 + T2)/S | 0.62 | 0.63 | 0.63 | 0.62 | 0.63 | 0.63 | 0.65 | 0.73 | 0.12 | 0.21 |
| | The number of | 5 | 5 | 5 | 5 | 5 | 5 | 5 | 5 | 5 | 5 |
| | ring zones N1 | | | | | | | | | | |
| | The number of | 5 | 5 | 5 | 5 | 5 | 5 | 5 | 5 | 5 | 5 |
| | ring zones N2 | | | | | | | | | | |
| | Sweep angle | 85 | 85 | 85 | 75 | 95 | 100 | 85 | 150 | 85 | 85 |
| Ring zone angle | θ1 | 15 | 15 | 15 | 15 | 15 | 15 | 15 | 15 | 15 | 15 |
| | θ2 | 15 | 15 | 15 | 15 | 15 | 15 | 25 | 15 | 15 | 15 |
| | d1 | 0.188 | 0.218 | 0.218 | 0.188 | 0.224 | 0.218 | 0.248 | 0.217 | 0.290 | 0.281 |
| | d2 | 0.155 | 0.133 | 0.179 | 0.155 | 0.155 | 0.150 | 0.155 | 0.142 | 0.177 | 0.171 |

[Parameter List]

| | | Ex. 11 | Ex. 12 | Ex. 13 | Ex. 14 | Ex. 15 | Comp. Ex. 1 | Comp. Ex. 2 | Comp. Ex. 3 |
|---|---|---|---|---|---|---|---|---|---|
| | S | 1.976 | 1.976 | 1.976 | 1.976 | 1.975 | 1.975 | 1.976 | 1.976 |
| | S1 | 1.397 | 1.397 | 1.397 | 1.397 | 1.397 | 1.397 | 1.397 | 1.397 |
| | S2 | 1.397 | 1.397 | 1.397 | 1.397 | 1.397 | 1.397 | 1.397 | 1.397 |
| | L1 | 0.5 | 1.5 | 1.65 | 1 | 1 | 2.2 | 2 | 0.1 |
| | T1 | 0.62 | 0.55 | 0.6 | 0.6 | 0.6 | 0.6 | 0.6 | 0.3 |
| | T2 | 0.693 | 0.602 | 0.589 | 0.500 | 0.500 | 0.411 | 0.450 | 0.738 |
| | T | 1.313 | 1.152 | 1.189 | 1.100 | 1.100 | 1.011 | 1.050 | 1.038 |
| | L2 | 3.4 | 3.4 | 3.4 | 3.4 | 3.4 | 3.4 | 3.4 | 3.4 |
| | L2/S | 1.72 | 1.72 | 1.72 | 1.72 | 1.72 | 1.72 | 1.72 | 1.72 |
| | L1(T1 + T2)/S | 0.33 | 0.87 | 0.99 | 0.56 | 0.56 | 1.13 | 1.06 | 0.05 |
| | The number of | 5 | 5 | 5 | 15 | 15 | 5 | 5 | 5 |
| | ring zones N1 | | | | | | | | |
| | The number of | 5 | 5 | 5 | 10 | 10 | 5 | 5 | 5 |
| | ring zones N2 | | | | | | | | |
| | Sweep angle | 85 | 85 | 85 | 85 | 85 | 85 | 85 | 85 |
| Ring zone angle | θ1 | 15 | 15 | 15 | 15 | 15 | 15 | 15 | 15 |
| | θ2 | 15 | 15 | 15 | 15 | 15 | 15 | 15 | 15 |
| | d1 | 0.263 | 0.172 | 0.159 | 0.070 | 0.070 | 0.127 | 0.109 | 0.299 |
| | d2 | 0.160 | 0.105 | 0.097 | 0.066 | 0.066 | 0.077 | 0.066 | 0.183 |

N1, θ1 and d1 relate to the direction X, and N2, θ2 and d2 relate to the direction Y Irradiation groove exists

φ2 for each ring zone number (Y direction)

| | | | | | | | | | | | | | | | | | | |
|---|---|---|---|---|---|---|---|---|---|---|---|---|---|---|---|---|---|---|
| 1 | 52 | 57 | 47 | 52 | 52 | 57 | 52 | 55 | 57 | 57 | 57 | 57 | 57 | 57 | 57 | 57 | 57 | 57 |
| 2 | 52 | 57 | 47 | 52 | 52 | 57 | 52 | 55 | 57 | 57 | 57 | 57 | 57 | 57 | 57 | 57 | 57 | 57 |
| 3 | 52 | 57 | 47 | 52 | 52 | 50 | 52 | 55 | 57 | 57 | 57 | 57 | 57 | 57 | 57 | 57 | 57 | 57 |
| 4 | 52 | 57 | 47 | 52 | 52 | 50 | 52 | 55 | 57 | 57 | 57 | 57 | 57 | 57 | 57 | 57 | 57 | 57 |
| 5 | 52 | 57 | 47 | 52 | 52 | 50 | 52 | 55 | 57 | 57 | 57 | 57 | 57 | 57 | 57 | 57 | 57 | 57 |
| 6 | | | | | | | | | | | | | | 57 | 57 | | | |
| 7 | | | | | | | | | | | | | | 57 | 57 | | | |
| 8 | | | | | | | | | | | | | | 57 | 57 | | | |
| 9 | | | | | | | | | | | | | | 57 | 57 | | | |
| 10 | | | | | | | | | | | | | | 57 | 57 | | | |

φ1 for each ring zone number (X direction)

| | | | | | | | | | | | | | | | | | | |
|---|---|---|---|---|---|---|---|---|---|---|---|---|---|---|---|---|---|---|
| 1 | 59 | 54 | 54 | 59 | 53 | 54 | 35 | 40 | 54 | 54 | 54 | 54 | 54 | 54 | 54 | 54 | 54 | 54 |
| 2 | 51 | 46 | 45 | 51 | 47 | 46 | 35 | 40 | 46 | 46 | 46 | 46 | 46 | 54 | 54 | 46 | 46 | 46 |
| 3 | 43 | 38 | 38 | 43 | 41 | 38 | 35 | 40 | 38 | 38 | 38 | 38 | 38 | 54 | 54 | 38 | 38 | 38 |
| 4 | 35 | 30 | 30 | 35 | 35 | 30 | 35 | 40 | 30 | 30 | 30 | 30 | 30 | 46 | 46 | 30 | 30 | 30 |
| 5 | 27 | 22 | 22 | 27 | 29 | 22 | 35 | 40 | 22 | 22 | 22 | 22 | 22 | 46 | 46 | 22 | 22 | 22 |
| 6 | | | | | | | | | | | | | | 46 | 46 | | | |
| 7 | | | | | | | | | | | | | | 38 | 38 | | | |
| 8 | | | | | | | | | | | | | | 38 | 38 | | | |
| 9 | | | | | | | | | | | | | | 38 | 38 | | | |
| 10 | | | | | | | | | | | | | | 30 | 30 | | | |
| 11 | | | | | | | | | | | | | | 30 | 30 | | | |
| 12 | | | | | | | | | | | | | | 30 | 30 | | | |
| 13 | | | | | | | | | | | | | | 30 | 30 | | | |
| 14 | | | | | | | | | | | | | | 30 | 30 | | | |
| 15 | | | | | | | | | | | | | | 30 | 30 | | | |

The evaluation results for each of Examples 1 to 15 (Ex. 1 to Ex. 15) and Comparative examples 1 to 3 (Comp. Ex. 1 to Comp. Ex. 3) are shown in Table 2. As the performance of the optical element of an auxiliary light source unit, the greatest importance is placed on the “efficiency” defined with a calculation to divide (a quantity of light arriving at the screen SC [Lumen]) with (a quantity of light emitted from the LED light source [Lumen]). Although it is preferable that the efficiency is made as high as possible, the efficiency being 0.45 or more is a guide for an allowable range. Preferably, the efficiency is in a range of 0.5 or more. Further, the illumination intensity on the screen SC is maintained as high as possible, and it is desired that the illumination intensity is in a range of several hundreds or more Lumen. Furthermore, it is desired that the illumination intensity at the central portion of each of the top edge, the bottom edge, the left edge, and the right edge on the screen SC is about 40% relative to the illumination intensity at the center portion. Moreover, it is desired that the illumination intensity at the central portion of each of edges in the diagonal direction on the screen SC is about 20% relative to the illumination intensity at the center portion. However, it is desirable that the illumination intensity on a portion decreases monotonously as the position of the portion shifts from the center toward a periphery and the decreasing rate is preferably uniform.

TABLE 2
[Illumination intensity distribution evaluation result]

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| | Efficiency | 0.55 | 0.54 | 0.57 | 0.55 | 0.55 | 0.55 | 0.53 | 0.55 | 0.51 | 0.53 |
| | Center portion | 245 | 235 | 251 | 242 | 233 | 252 | 213 | 210 | 225 | 239 |
| | illumination | | | | | | | | | | |
| | intensity (Lux) | | | | | | | | | | |
| Ratio relative to | X direction | 0.54 | 0.54 | 0.56 | 0.58 | 0.60 | 0.57 | 0.62 | 0.71 | 0.56 | 0.56 |
| center portion | (end portion) | | | | | | | | | | |
| illumination intensity | | | | | | | | | | | |
| Ratio relative to | Y direction | 0.56 | 0.53 | 0.48 | 0.55 | 0.59 | 0.51 | 0.55 | 0.52 | 0.56 | 0.49 |
| center portion | (end portion) | | | | | | | | | | |
| illumination intensity | | | | | | | | | | | |
| Ratio relative to | Diagonal | 0.24 | 0.23 | 0.21 | 0.27 | 0.29 | 0.28 | 0.27 | 0.27 | 0.33 | 0.28 |
| center portion | | | | | | | | | | | |
| illumination intensity | | | | | | | | | | | |

| | | | | | | | Comp. | Comp. | Comp. |
|---|---|---|---|---|---|---|---|---|---|
| | | Ex. 11 | Ex. 12 | Ex. 13 | Ex. 14 | Ex. 15 | Ex. 1 | Ex. 2 | Ex. 3 |
| | Efficiency | 0.54 | 0.50 | 0.49 | 0.54 | 0.49 | 0.43 | 0.39 | 0.44 |
| | Center portion | 238 | 232 | 232 | 237 | 208 | 147 | 178 | 181 |
| | illumination | | | | | | | | |
| | intensity (Lux) | | | | | | | | |
| Ratio relative to | X direction | 0.56 | 0.55 | 0.53 | 0.55 | 0.58 | 0.73 | 0.63 | 0.65 |
| center portion | (end portion) | | | | | | | | |
| illumination intensity | | | | | | | | | |
| Ratio relative to | Y direction | 0.53 | 0.56 | 0.55 | 0.54 | 0.58 | 0.74 | 0.66 | 0.64 |
| center portion | (end portion) | | | | | | | | |
| illumination intensity | | | | | | | | | |
| Ratio relative to | Diagonal | 0.30 | 0.28 | 0.27 | 0.32 | 0.35 | 0.44 | 0.36 | 0.38 |
| center portion | | | | | | | | | |
| illumination intensity | | | | | | | | | |

As being clear from Table 2, in Examples 1 to 15 each satisfying the expressions (1) to (3), since the “efficiency” was 0.49 or more, it turned out that each of Examples 1 to 15 was sufficiently practical. In contrast, in Comparative examples 1 to 3, since the “efficiency” was 0.44 or less, it turned out that each of Comparative examples 1 to 3 was not suitable for practical use. Further, the illumination intensity at the center portion on the screen SC was 208 Lumen or more, the illumination intensity at the central portion of each of the top edge and the bottom edge on the screen SC was 53% to 71% relative to the illumination intensity at the center portion, the illumination intensity at the central portion of each of the left edge and the right edge on the screen SC is 48% to 58% relative to the illumination intensity at the center portion, and the illumination intensity at the central portion of each of edges in the diagonal directions on the screen SC is 21% to 35% relative to the illumination intensity at the center portion. Accordingly, it turned out that such an illumination intensity was sufficiently practical. In contrast, in Comparative examples 1 to 3, the illumination intensity at the center portion on the screen SC was 181 Lumen or less, the illumination intensity at the central portion of each of the top edge and the bottom edge on the screen SC was 63% to 73% relative to the illumination intensity at the center portion, the illumination intensity at the central portion of each of the left edge and the right edge on the screen SC was 64% to 74% relative to the illumination intensity at the center portion, and the illumination intensity at the central portion of each of edges in the diagonal directions on the screen SC was 36% to 44% relative to the illumination intensity at the center portion. Accordingly, although the uniformity of the illumination intensity on the screen SC was high, since the illumination intensity at the center portion was low, it turned out that such an illumination intensity was not suitable for practical use.

The present invention should not be limited to the examples described in the specification, and for a person skilled in the art, it is clear from the examples and concepts described in the specification that the present invention includes the other examples and modified examples. The description and examples described in the specification is intended to disclose exemplification, and the scope of the present invention is shown with claims mentioned later. For example, the top portion of the partial ring zone may be rounded without being sharpened. Further, at the light exiting surface side of an optical element, a positioning structure used at the time of attaching an optical element to an LED light source may be formed. It is possible to form the positioning structure by a monolithic molding process. Furthermore, on the periphery of the optical element, a discrimination mark to indicate the X direction or the Y direction is exemplified with the boss-shaped mark. However, as far as a direction can be discriminated, the discrimination mark may be formed at any position, and the discrimination mark may be a discrimination mark and a symbol used to discriminate the direction of light distribution.

Moreover, the mobile electronic devices in which the optical element of the present invention can be applied as a lens for flash should not be limited to a smart phone, and for example, a mobile telephone, a PDA (Personal Digital Assistance), and the like may be used as the mobile electronic devices.

### REFERENCE SIGNS LIST

10 Auxiliary light source unit
11 Base plate
12 Light source
12a Top face
13 Optical element
13a Parallel flat plate
13b Light transmitting section
13c Ring zone section
13cx First fan-shaped portion
13cy Second fan-shaped portion
14 Spacer
14a Inner circumference surface
15 Mountain-shaped upraised portion
21 Protruding portion
M1 and M2 Metal mold
OA Optical axis
OPx Optical axis outer side surface
OPy Optical axis outer side surface
RPx Partial ring zone
RPy Partial ring zone
SC Screen

1. An auxiliary light source unit, comprising:
an LED light source; and
an optical element disposed at a light emitting side of the LED light source;
wherein the optical element includes, at a light exiting side thereof, a light transmitting section which is shaped in a flat surface or a curved surface and is disposed at a position corresponding to a central portion of the LED light source, and a ring zone section configured to enclose a periphery of the light transmitting section,
wherein the ring zone section is divided in a circumferential direction into four sections which include a first pair of fan-shaped portions arranged to face each other across the light transmitting section and a second pair of fan-shaped portions arranged to be disposed between the first pair of fan-shaped portions,
wherein each of the first pair of fan-shaped portions includes a plurality of first partial ring zones each provided with an optical axis side surface and an optical axis outer side surface,
wherein each of the second pair of f fan-shaped portions includes a plurality of second partial ring zones each provided with an optical axis side surface and an optical axis outer side surface,
wherein respective slope angles of the optical axis outer side surfaces of the first partial ring zones relative to the optical axis and respective slope angles of the optical axis outer side surfaces of the second partial ring zones relative to the optical axis are made different in at least a part thereof from each other,
wherein when the longest length of a light emitting face of the LED light source is S (mm), the furthest distance from the light emitting face of the LED light source to the light exiting surface of the optical element is T (mm), the largest diameter of the light transmitting section is L1 (mm), and the largest diameter in the first partial ring zones and the second partial ring zones is L2 (mm), the following conditional expressions are satisfied,
1.5<L2/S<4.0 (1)
S/3<T<2S (2)
0.1<L1·T/S<1.05 (3)
provided that T=T1+T2,
where T1 is a thickness (mm) from the light emitting face of the LED light source to the light entering surface of the optical element, and T2 is a thickness (mm), in the optical axis direction, of the optical element.

2. The auxiliary light source unit described in claim 1, wherein the following expression is satisfied.
T2/T<0.5 (4)

3. The auxiliary light source unit described in claim 1, wherein a mountain-shaped upraised portion is disposed in a boundary between the first partial ring zone and the second partial ring zone.

4. The auxiliary light source unit described in claim 1, wherein the slope angle of the optical axis outer side surface of at least one of the first partial ring zone and the second partial ring zone decreases gradually from a side near the optical axis toward a peripheral portion.

5. The auxiliary light source unit described in claim 1, wherein a groove depth in a ring zone of at least one of the first partial ring zone and the second partial ring zone increases from a side near the optical axis toward a peripheral portion.

6. The auxiliary light source unit described in claim 1, wherein on the optical element, a discrimination mark to discriminate the first pair of fan-shaped portions and the second pair of fan-shaped portions from each other is formed.

7. An optical element configured to be disposed at a light emitting side of an LED light source in an auxiliary light source unit including the LED light source, comprising:
a light transmitting section, at a light exiting side thereof, which is disposed at a position corresponding to a central portion of the LED light source and shaped in a flat surface or a curved surface; and
a ring zone section configured to enclose a periphery of the light transmitting section;
wherein the ring zone section is divided in a circumferential direction into four sections which include a first pair of fan-shaped portions arranged to face each other across the light transmitting section and a second pair of fan-shaped portions arranged to be disposed between the first pair of fan-shaped portions,
wherein each of the first pair of fan-shaped portions includes a plurality of first partial ring zones each provided with an optical axis side surface and an optical axis outer side surface,
wherein each of the second pair of fan-shaped portions includes a plurality of second partial ring zones each provided with an optical axis side surface and an optical axis outer side surface,
wherein respective slope angles of the optical axis outer side surfaces of the first partial ring zones relative to the optical axis and respective slope angles of the optical axis outer side surfaces of the second partial ring zones relative to the optical axis are made different in at least a part thereof from each other,
wherein when the longest length of a light emitting face of the LED light source is S (mm), the furthest distance from the light emitting face of the LED light source to the light exiting surface of the optical element is T (mm), the largest diameter of the light transmitting section is L1 (mm), and the largest diameter in the first partial ring zones and the second partial ring zones is L2 (mm), the following conditional expressions are satisfied,
1.5<L2/S<4.0 (1)
S/3<T<2S (2)
0.1<L1·T/S<1.05 (3)
provided that T=T1+T2,
where T1 is a thickness (mm) from the light emitting face of the LED light source to the light entering surface of the optical element, and T2 is a thickness (mm), in the optical axis direction, of the optical element.

8. A mobile electronic device, comprising:
the auxiliary light source unit described in claim 1.
